(19) United States
(12) Patent Application Publication
(10) Pub. No.: US 2013/0161491 A1
(43) Pub. Date: Jun. 27, 2013

(54) OPTICAL TOUCH CONTROL MODULE

(71) Applicants: CHUN-YU LU, NEW TAIPEI CITY (TW); CHI-HSING HSU, NEW TAIPEI CITY (TW)

(72) Inventors: CHUN-YU LU, NEW TAIPEI CITY (TW); CHI-HSING HSU, NEW TAIPEI CITY (TW)

(73) Assignee: AZUREWAVE TECHNOLOGIES, INC., NEW TAIPEI CITY (TW)

(21) Appl. No.: 13/353,412

(22) Filed: Jan. 19, 2012

(30) Foreign Application Priority Data
Dec. 23, 2011 (TW) 100148269

(51) Int. Cl. G01J 1/42

(52) U.S. Cl. 250/208.3

(57) ABSTRACT

An optical touch control module for providing at least one sensing area includes: a light-reflecting unit, a first light-sensing unit and a second light-sensing unit. The light-reflecting unit includes a light-reflecting element for partially surrounding the sensing area. The first light-sensing unit is disposed beside one edge of the at least one sensing area and adjacent to one end of the light-reflecting element. The first light-sensing unit includes at least one first light-emitting element, at least one first light-detecting element, and at least one first oscillating reflecting element oscillating depending on time. The second light-sensing unit is disposed beside another edge of the at least one sensing area and adjacent to another end of the light-reflecting element. The second light-sensing unit includes at least one second light-emitting element, at least one second light-detecting element, and at least one second oscillating reflecting element oscillating depending on time.

### BACKGROUND OF THE INVENTION

1. Field of the Invention

The instant disclosure relates to a touch control module, and more particularly, to an optical touch control module.

2. Description of Related Art

In recent years, for a touch screen (i.e., a touch panel), the conventional mechanical press-button operation is replaced by a direct touch operation with an object or a finger on the screen. When a user touches an icon on the screen, various connecting units are driven by a touch feedback system on the screen according to a preset program, and a vivid video and audio effect is presented on a frame of the screen.

The commonly used touch screens employ resistive, capacitive, acoustic wave, and optical touch modes. A resistive touch screen adopts two sets of indium tin oxide (ITO) conductive layers separated by a spacer, and when applied, upper and lower electrodes are conducted under pressure to detect voltage changes on the screen so as to calculate the contact position for input. A capacitive touch screen adopts capacity changes generated from the combination of static electricity between arranged transparent electrodes and a human body, so as to detect coordinates of the contact position through a generated induced current. An acoustic wave touch screen first converts an electric signal into an ultrasonic wave through a transducer, and then directly transmits the ultrasonic wave through a surface of the touch panel. When the touch panel is used, the ultrasonic wave may be absorbed by contacting a pointer to cause attenuation, and an accurate position of the contact is obtained through comparison and calculation between attenuation amounts before and after use.

An optical touch screen utilizes the principle of light source reception and blocking When light rays are blocked, the position of a receiver that is unable to receive a signal is obtained, and an accurate position thereof is further determined. Components of the optical touch screen include a glass substrate, a light emitting device, a light receiver, and a lens. The light emitting device and the light receiver are disposed at an upper right corner of the glass substrate, and light-reflecting bars are disposed on the left side and lower side of the glass substrate. The far-end light-reflecting bars are illuminated by the light emitting device, and when a finger or a contact object blocks the light rays, the light receiver may collect a relative position of the finger or the contact object on the glass substrate through the lens.

### SUMMARY OF THE INVENTION

One aspect of the instant disclosure relates to an optical touch control module that can provide an oscillating reflecting element oscillating depending on time in order to generate scanning light beams that can scan depending on time in at least one sensing area.

One of the embodiments of the instant disclosure provides an optical touch control module for providing at least one sensing area, comprising: a light-reflecting unit, a first light-sensing unit and a second light-sensing unit. The light-reflecting unit includes a light-reflecting element for partially surrounding the at least one sensing area. The first light-sensing unit is disposed beside one edge of the at least one sensing area and adjacent to one end of the light-reflecting element, wherein the first light-sensing unit includes at least one first light-emitting element, at least one first light-detecting element adjacent to the at least one first light-emitting element, and at least one first oscillating reflecting element oscillating depending on time and adjacent to the at least one first light-emitting element and the at least one first light-detecting element. The second light-sensing unit is disposed beside another edge of the at least one sensing area and adjacent to another end of the light-reflecting element, wherein the second light-sensing unit includes at least one second light-emitting element, at least one second light-detecting element adjacent to the at least one second light-emitting element, and at least one second oscillating reflecting element oscillating depending on time and adjacent to the at least one second light-emitting element and the at least one second light-detecting element.

Hence, first projecting light beams generating by the at least one first light-emitting element are reflected by the at least one first oscillating reflecting element to form first scanning light beams projecting onto the light-reflecting element and scanning depending on time in the at least one sensing area, and the first scanning light beams are sequentially reflected by the light-reflecting element and the at least one first oscillating reflecting element to form first reflecting light beams projecting onto the at least one first light-detecting element. In addition, second projecting light beams generating by the at least one second light-emitting element are reflected by the at least one second oscillating reflecting element to form second scanning light beams projecting onto the light-reflecting element and scanning depending on time in the at least one sensing area, and the second scanning light beams are sequentially reflected by the light-reflecting element and the at least one second oscillating reflecting element to form second reflecting light beams projecting onto the at least one second light-detecting element.

Another one of the embodiments of the instant disclosure provides an optical touch control module for providing at least one sensing area, comprising: a light-reflecting unit and a light-sensing unit. The light-reflecting unit includes a light-reflecting element for partially surrounding the at least one sensing area. The light-sensing unit is disposed beside one edge of the at least one sensing area and adjacent to one end of the light-reflecting element, wherein the light-sensing unit includes at least one light-emitting element, at least one light-detecting element adjacent to the at least one light-emitting element, and at least one oscillating reflecting element oscillating depending on time and adjacent to the at least one light-emitting element and the at least one light-detecting element. Hence, projecting light beams generating by the at least one light-emitting element are reflected by the at least one oscillating reflecting element to form scanning light beams projecting onto the light-reflecting element and scanning depending on time in the at least one sensing area, and the scanning light beams are sequentially reflected by the light-reflecting element and the at least one oscillating reflecting element to form reflecting light beams projecting onto the at least one light-detecting element.

Yet another one of the embodiments of the instant disclosure provides an optical touch control module for providing at least one sensing area, comprising: a light-reflecting unit and a light-sensing unit. The light-reflecting unit includes a light-reflecting element for partially surrounding the at least one sensing area. The light-sensing unit is disposed beside one edge of the at least one sensing area and adjacent to one end of the light-reflecting element, wherein the light-sensing unit includes at least one light-emitting element for providing a first phase signal, at least one light-detecting element adjacent to the at least one light-emitting element for receiving a second phase signal in order to obtain the phase difference between the first phase signal and the second phase signal, and at least one oscillating reflecting element oscillating depending on time and adjacent to the at least one light-emitting element and the at least one light-detecting element.

Therefore, the optical touch control module of the instant disclosure can provide the scanning light beams that can scan depending on time in at least one sensing area due to the design of the oscillating reflecting element that can oscillate depending on time.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1 shows a top, schematic view of the optical touch control module according to the first embodiment of the instant disclosure;

FIG. 2 shows a top, schematic view of the optical touch control module according to the second embodiment of the instant disclosure;

FIG. 3 shows a top, schematic view of the optical touch control module according to the third embodiment of the instant disclosure;

FIG. 4 shows a top, schematic view of the optical touch control module according to the fourth embodiment of the instant disclosure;

FIG. 5 shows a top, schematic view of the optical touch control module according to the fifth embodiment of the instant disclosure;

FIG. 6 shows a top, schematic view of the optical touch control module according to the sixth embodiment of the instant disclosure; and

FIG. 7 shows a top, schematic view of the optical touch control module according to the seventh embodiment of the instant disclosure.

### DETAILED DESCRIPTION OF THE PREFERRED EMBODIMENTS

### First Embodiment

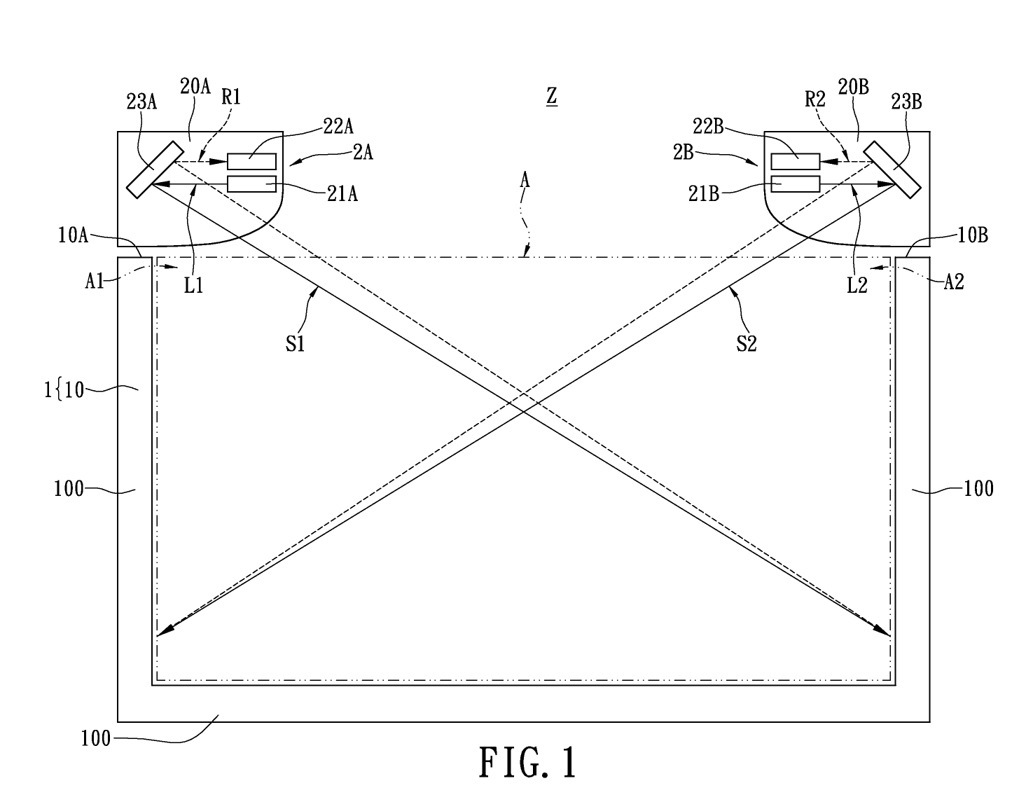

Referring to FIG. 1, where the first embodiment of the instant disclosure provides an optical touch control module Z for providing at least one sensing area A, comprising: a light-reflecting unit 1, a first light-sensing unit 2A and a second light-sensing unit 2B. The optical touch control module Z can be controlled or operated by moving user's finger (not shown) in the at least one sensing area A.

Moreover, the light-reflecting unit 1 includes a light-reflecting element 10 for partially surrounding the at least one sensing area A. For example, the light-reflecting element 10 may be composed of at least three U-shaped reflecting bars 100 sequentially connected with each other. In other words, the at least three U-shaped reflecting bars 100 are respectively close to three sides of the at least one sensing area A, thus the at least one sensing area A can be partially surrounded by the light-reflecting element 10.

Furthermore, the first light-sensing unit 2A may be disposed beside one edge A1 of the at least one sensing area A and adjacent to one end 10A of the light-reflecting element 10. The first light-sensing unit 2A includes at least one first light-emitting element 21A, at least one first light-detecting element 22A adjacent to the at least one first light-emitting element 21A, and at least one first oscillating reflecting element 23A oscillating depending on time and adjacent to the at least one first light-emitting element 21A and the at least one first light-detecting element 22A. In addition, the first light-sensing unit 2A may further include a first substrate 20A adjacent to one end 10A of the light-reflecting element 10, and the at least one first light-emitting element 21A, the at least one first light-detecting element 22A and the at least one first oscillating reflecting element 23A may be disposed on the first substrate 20A. For example, the at least one first light-emitting element 21A may be a LED or laser etc. The at least one first light-detecting element 22A may be light sensor. The at least one first oscillating reflecting element 23A may be a MEMS (Micro Electronic Mechanic System) oscillating reflector, and the MEMS oscillating reflector may be composed of a plurality of oscillatable or swingable mirrors.

Hence, when first projecting light beams L1 (such as invisible light) generating by the at least one first light-emitting element 21A are reflected by the at least one first oscillating reflecting element 23A, the first projecting light beams L1 can be transformed into first scanning light beams S1 projecting onto the light-reflecting element 10, and the first scanning light beams S1 is scanning depending on time in the at least one sensing area A. When the first scanning light beams S1 are sequentially reflected by the light-reflecting element 10 and the at least one first oscillating reflecting element 23A, the first scanning light beams S1 can be transformed into first reflecting light beams R1 projecting onto the at least one first light-detecting element 22A. In other words, the first projecting light beams L1 generating by the at least one first light-emitting element 21A are reflected by the at least one first oscillating reflecting element 23A to form the first scanning light beams S1 that can project onto the light-reflecting element 10 and scan depending on time in the at least one sensing area A, and the first scanning light beams S1 are sequentially reflected by the light-reflecting element 10 and the at least one first oscillating reflecting element 23A to form the first reflecting light beams R1 projecting onto the at least one first light-detecting element 22A.

In addition, the second light-sensing unit 2B may be disposed beside another edge A2 of the at least one sensing area A and adjacent to another end 10B of the light-reflecting element 10. The second light-sensing unit 2B includes at least one second light-emitting element 21B, at least one second light-detecting element 22B adjacent to the at least one second light-emitting element 21B, and at least one second oscillating reflecting element 23B oscillating depending on time and adjacent to the at least one second light-emitting element 21B and the at least one second light-detecting element 22B. In addition, the second light-sensing unit 2B may further include a second substrate 20B adjacent to another end 10B of the light-reflecting element 10, and the at least one second light-emitting element 21B, the at least one second light-detecting element 22B and the at least one second oscillating reflecting element 23B may be disposed on the second substrate 20B. For example, the at least one second light-emitting element 21B may be a LED or laser etc. The at least one second light-detecting element 22B may be light sensor. The at least one second oscillating reflecting element 23B may be a MEMS (Micro Electronic Mechanic System) oscillating reflector, and the MEMS oscillating reflector may be composed of a plurality of oscillatable or swingable mirrors.

Hence, when second projecting light beams L2 (such as invisible light) generating by the at least one second light-emitting element 21B are reflected by the at least one second oscillating reflecting element 23B, the second projecting light beams L2 can be transformed into second scanning light beams S2 projecting onto the light-reflecting element 10, and the second scanning light beams S2 is scanning depending on time in the at least one sensing area A. When the second scanning light beams S2 are sequentially reflected by the light-reflecting element 10 and the at least one second oscillating reflecting element 23B, the second scanning light beams S2 can be transformed into second reflecting light beams R2 projecting onto the at least one second light-detecting element 22B. In other words, the second projecting light beams L2 generating by the at least one second light-emitting element 21B are reflected by the at least one second oscillating reflecting element 23B to form the second scanning light beams S2 that can project onto the light-reflecting element 10 and scan depending on time in the at least one sensing area A, and the second scanning light beams S2 are sequentially reflected by the light-reflecting element 10 and the at least one second oscillating reflecting element 23B to form the second reflecting light beams R2 projecting onto the at least one second light-detecting element 22B.

Therefore, the first scanning light beams S1 and the second scanning light beams S2 can be used to scan in the at least one sensing area A and depending on time, thus space coordinate (x, y) of the finger (not shown) of the user in the at least one sensing area A can be transformed into time coordinate (t) by light scanning of the first scanning light beams S1 and the second scanning light beams S2. In addition, when the first reflecting light beams R1 and the second reflecting light beams R2 are respectively projected onto the at least one first light-detecting element 22A and the at least one second light-detecting element 22B, the time coordinate (t) can be transformed into the space coordinate (x, y) of the finger (not shown) of the user in the at least one sensing area A, thus the correct coordinate position of the finger (not shown) of the user in the at least one sensing area A can be obtain.

### Second Embodiment

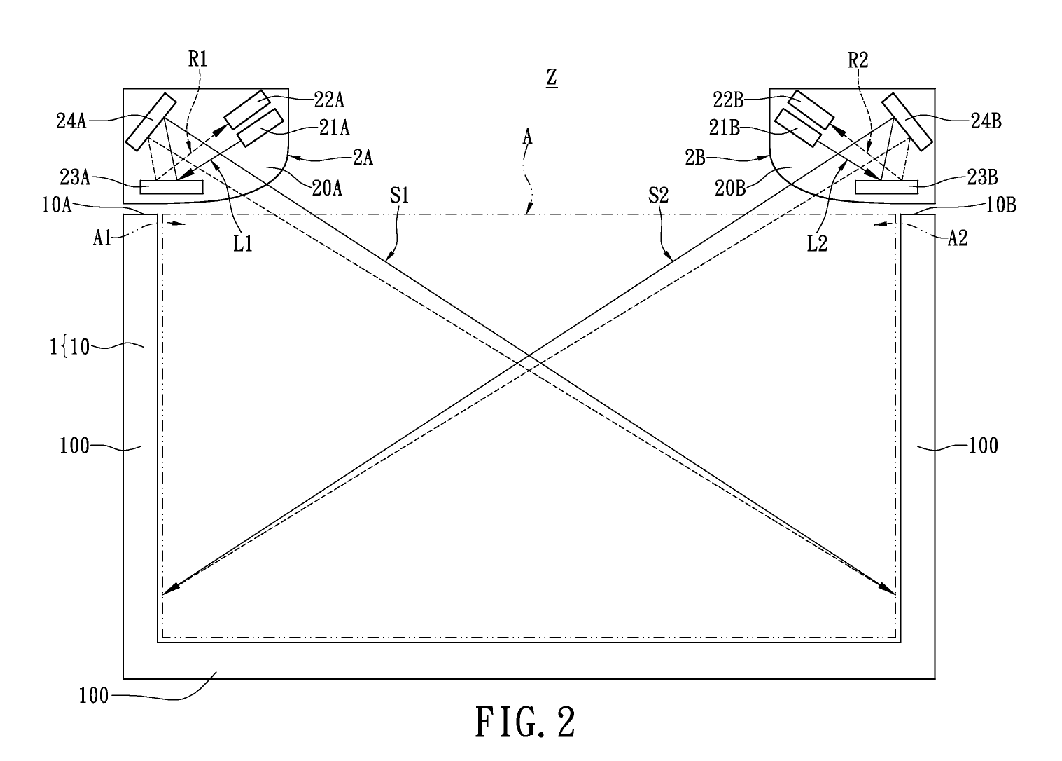

Referring to FIG. 2, where the second embodiment of the instant disclosure provides an optical touch control module Z for providing at least one sensing area A, comprising: a light-reflecting unit 1, a first light-sensing unit 2A and a second light-sensing unit 2B. Comparing FIG. 2 with FIG. 1, the difference between the second embodiment and the first embodiment is as follows: in the second embodiment, the first light-sensing unit 2A further includes at least one first fixed reflecting element 24A adjacent to the at least one first oscillating reflecting element 23A, and the second light-sensing unit 2B further includes at least one second fixed reflecting element 24B adjacent to the at least one second oscillating reflecting element 23B. In addition, the at least one first oscillating reflecting element 23A and the at least one second oscillating reflecting element 23B can be disposed transversely along a horizontal direction as shown in FIG. 2, thus the height of the optical touch control module Z can be effectively decreased.

Hence, first projecting light beams L1 generating by the at least one first light-emitting element 21A are sequentially reflected by the at least one first oscillating reflecting element 23A and the at least one first fixed reflecting element 24A to form first scanning light beams S1 that can project onto the light-reflecting element 10 and scan depending on time in the at least one sensing area A, and the first scanning light beams S1 are sequentially reflected by the light-reflecting element 10, the at least one first fixed reflecting element 24A and the at least one first oscillating reflecting element 23A to form first reflecting light beams R1 projecting onto the at least one first light-detecting element 22A. In addition, second projecting light beams L2 generating by the at least one second light-emitting element 21B are sequentially reflected by the at least one second oscillating reflecting element 23B and the at least one second fixed reflecting element 24B to form second scanning light beams S2 that can project onto the light-reflecting element 10 and scan depending on time in the at least one sensing area A, and the second scanning light beams S2 are sequentially reflected by the light-reflecting element 10, the at least one first fixed reflecting element 24B and the at least one second oscillating reflecting element 23B to form second reflecting light beams R2 projecting onto the at least one second light-detecting element 22B.

### Third Embodiment

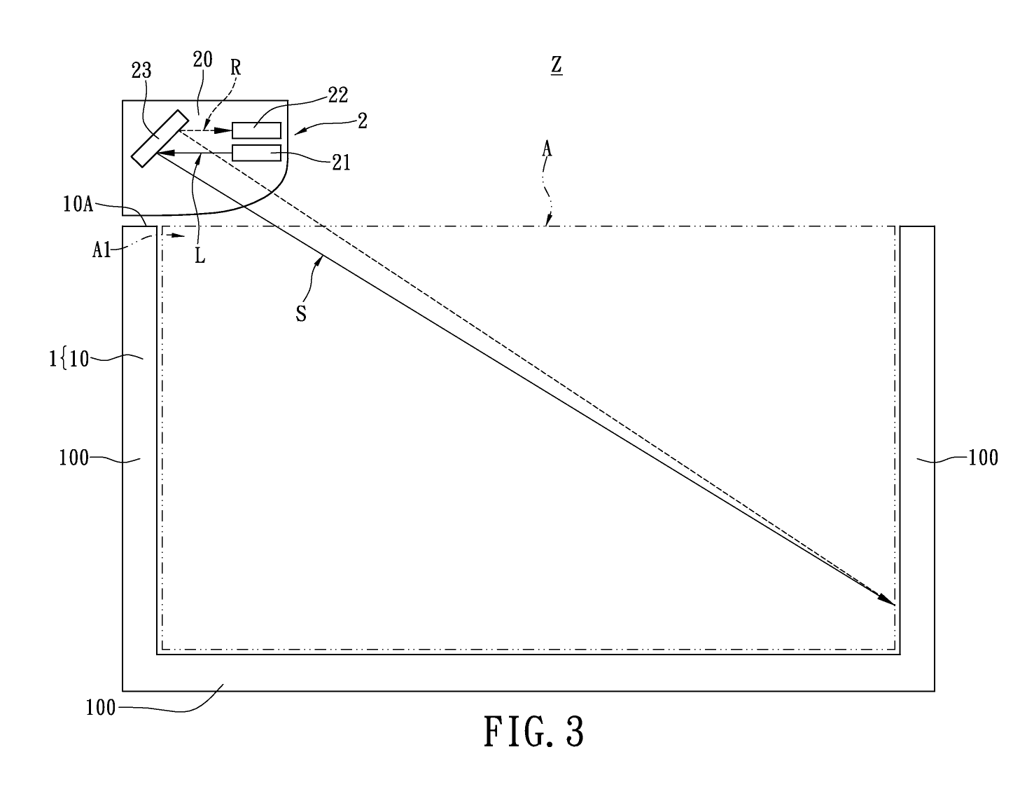

Referring to FIG. 3, where the third embodiment of the instant disclosure provides an optical touch control module Z for providing at least one sensing area A, comprising: a light-reflecting unit 1 and a light-sensing unit 2. Comparing FIG. 3 with FIG. 1, the difference between the third embodiment and the first embodiment is as follows: the third embodiment uses a single light-sensing unit 2. The light-sensing unit 2 may be disposed beside one edge A1 of the at least one sensing area A and adjacent to one end 10A of the light-reflecting element 10. The light-sensing unit 2 includes at least one light-emitting element 21, at least one light-detecting element 22 adjacent to the at least one light-emitting element 21, and at least one oscillating reflecting element 23 oscillating depending on time and adjacent to the at least one light-emitting element 21 and the at least one light-detecting element 22. In addition, the light-sensing unit 2 may further include a substrate 20 adjacent to one end 10A of the light-reflecting element 10, and the light-emitting element 21, the light-detecting element 22 and the oscillating reflecting element 23 may be disposed on the substrate 20. For example, the oscillating reflecting element 23 may be a MEMS oscillating reflector, thus projecting light beams L generating by the at least one light-emitting element 21 are reflected by the at least one oscillating reflecting element 23 to form scanning light beams S that can project onto the light-reflecting element 10 and scan depending on time in the at least one sensing area A, and the scanning light beams S are sequentially reflected by the light-reflecting element 10 and the at least one oscillating reflecting element 23 to form the reflecting light beams R projecting onto the at least one light-detecting element 22.

### Fourth Embodiment

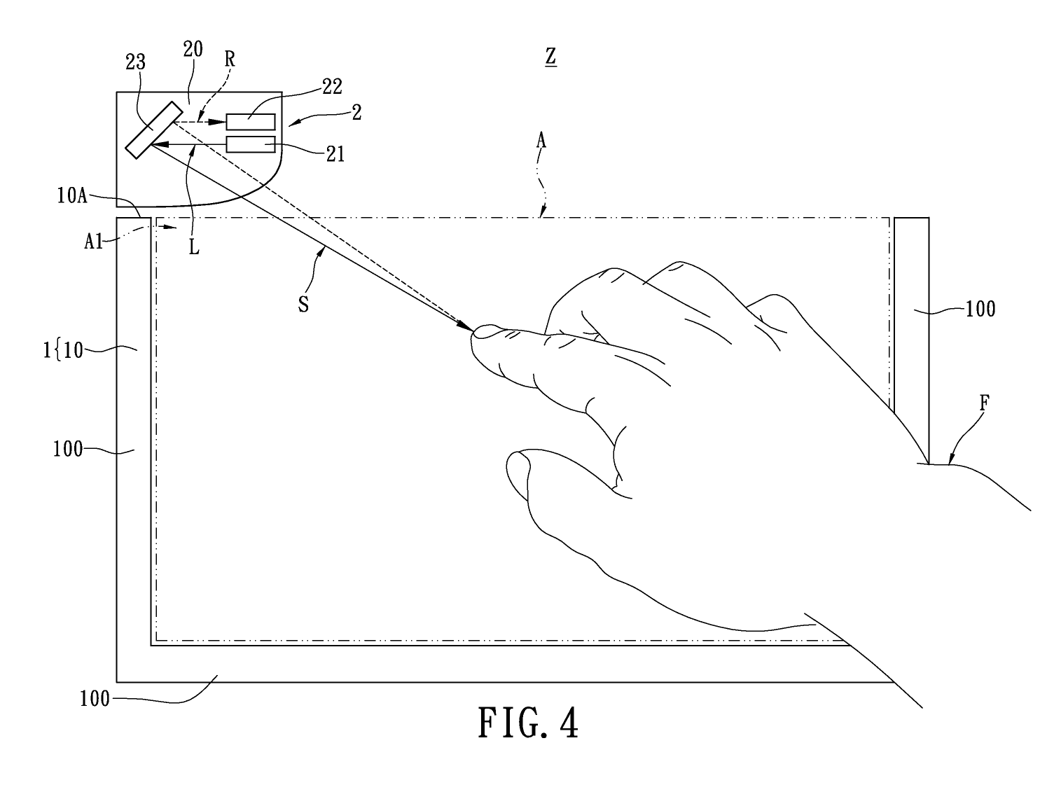

Referring to FIG. 4, where the fourth embodiment of the instant disclosure provides an optical touch control module Z for providing at least one sensing area A, comprising: a light-reflecting unit 1 and a light-sensing unit 2. Comparing FIG. 4 with FIG. 3, the difference between the fourth embodiment and the third embodiment is as follows: in the fourth embodiment, the light-sensing unit 2 is disposed beside one edge A1 of the at least one sensing area A and adjacent to one end 10A of the light-reflecting element 10. In addition, the light-sensing unit 2 includes at least one light-emitting element 21 for providing a first phase signal, at least one light-detecting element 22 adjacent to the at least one light-emitting element 21 for receiving a second phase signal in order to obtain the phase difference between the first phase signal and the second phase signal, and at least one oscillating reflecting element 23 oscillating depending on time and adjacent to the at least one light-emitting element 21 and the at least one light-detecting element 22.

Hence, the projecting light beams L generating by the at least one light-emitting element 21 can provide the first phase signal, thus when the scanning light beams S are sequentially reflected by a finger F and the at least one oscillating reflecting element 23 to form the reflecting light beams R projecting onto the at least one light-detecting element 22, the at least one light-detecting element 22 can receive the second phase signal from the reflecting light beams R to figure out the phase difference between the first phase signal and the second phase signal. Therefore, the correct coordinate position of the finger F of the user can be obtained by using the single light-sensing unit 2.

### Fifth Embodiment

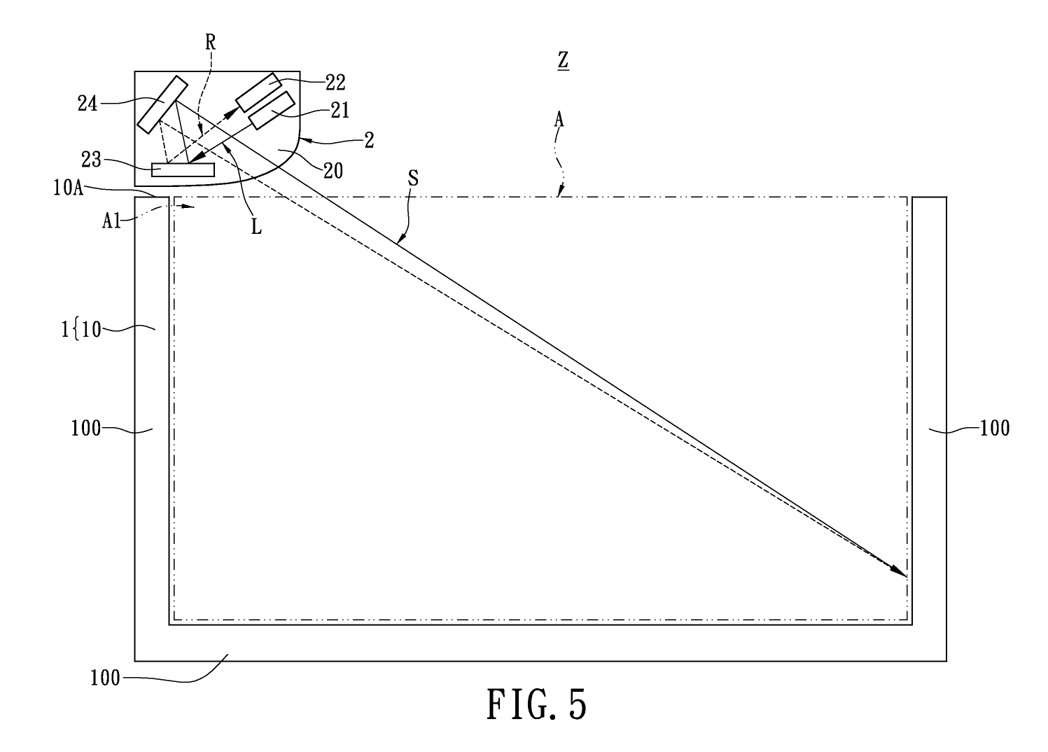

Referring to FIG. 5, where the fifth embodiment of the instant disclosure provides an optical touch control module Z for providing at least one sensing area A, comprising: a light-reflecting unit 1 and a light-sensing unit 2. Comparing FIG. 5 with FIG. 3, the difference between the fifth embodiment and the third embodiment is as follows: in the fifth embodiment, the light-sensing unit 2 further includes at least one fixed reflecting element 24 adjacent to the at least one oscillating reflecting element 23. In addition, the at least one oscillating reflecting element 23 can be disposed transversely along a horizontal direction as shown in FIG. 5, thus the height of the optical touch control module Z can be effectively decreased.

Hence, projecting light beams L generating by the at least one light-emitting element 21 are sequentially reflected by the at least one oscillating reflecting element 23 and the at least one fixed reflecting element 24 to form scanning light beams S that can project onto the light-reflecting element 10 and scan depending on time in the at least one sensing area A, and the scanning light beams S are sequentially reflected by the light-reflecting element 10, the at least one fixed reflecting element 24 and the at least one oscillating reflecting element 23 to form reflecting light beams R projecting onto the at least one light-detecting element 22. In other words, the projecting light beams L generating by the at least one light-emitting element 21 are sequentially reflected by the at least one oscillating reflecting element 23 and the at least one fixed reflecting element 24 to form the scanning light beams S that can project onto the light-reflecting element 10 and scan depending on time in the at least one sensing area A, and the scanning light beams S are sequentially reflected by the light-reflecting element 10, the at least one fixed reflecting element 24 and the at least one oscillating reflecting element 23 to form the reflecting light beams R projecting onto the at least one light-detecting element 22.

### Sixth Embodiment

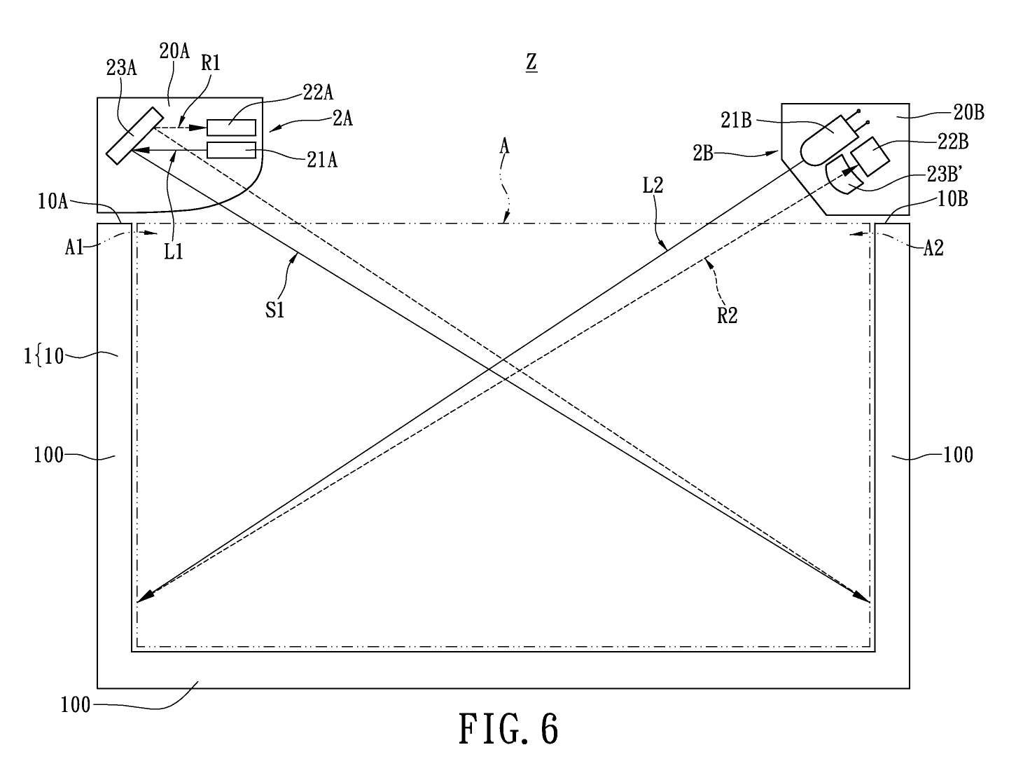

Referring to FIG. 6, where the sixth embodiment of the instant disclosure provides an optical touch control module Z for providing at least one sensing area A, comprising: a light-reflecting unit 1, a first light-sensing unit 2A and a second light-sensing unit 2B. Comparing FIG. 6 with FIG. 1, the difference between the sixth embodiment and the first embodiment is as follows: the sixth embodiment can use another second light-sensing unit 2B to replace the second light-sensing unit 2B in the first embodiment. In addition, the second light-sensing unit 2B of the second embodiment is disposed beside another edge A2 of the at least one sensing area A and adjacent to another end 10B of the light-reflecting element 10. The second light-sensing unit 2B includes at least one second light-emitting element 21B, at least one second light-detecting element 22B adjacent to the at least one second light-emitting element 21B, and at least one lens element 23B′ adjacent to the at least one second light-emitting element 21B and the at least one second light-detecting element 22B. Furthermore, the second light-sensing unit 2B include a second substrate 20B adjacent to another end 10B of the light-reflecting element 10, and the at least one second light-emitting element 21B, the at least one second light-detecting element 22B and the at least one lens element 23B′ are disposed on the second substrate 20B.

For example, when second projecting light beams L2 generating by the at least one second light-emitting element 21B are reflected by the light-reflecting element 10, the second projecting light beams L2 can be transformed into second reflecting light beams R2, and the second reflecting light beams R2 can pass through the at least one lens element 23B′ and be projected onto the at least one second light-detecting element 22B. In other words, the second projecting light beams L2 generating by the at least one second light-emitting element 21B are reflected by the light-reflecting element 10 to form the second reflecting light beams R2 that can be projected onto the at least one second light-detecting element 22B through the at least one lens element 23B′.

### Seventh Embodiment

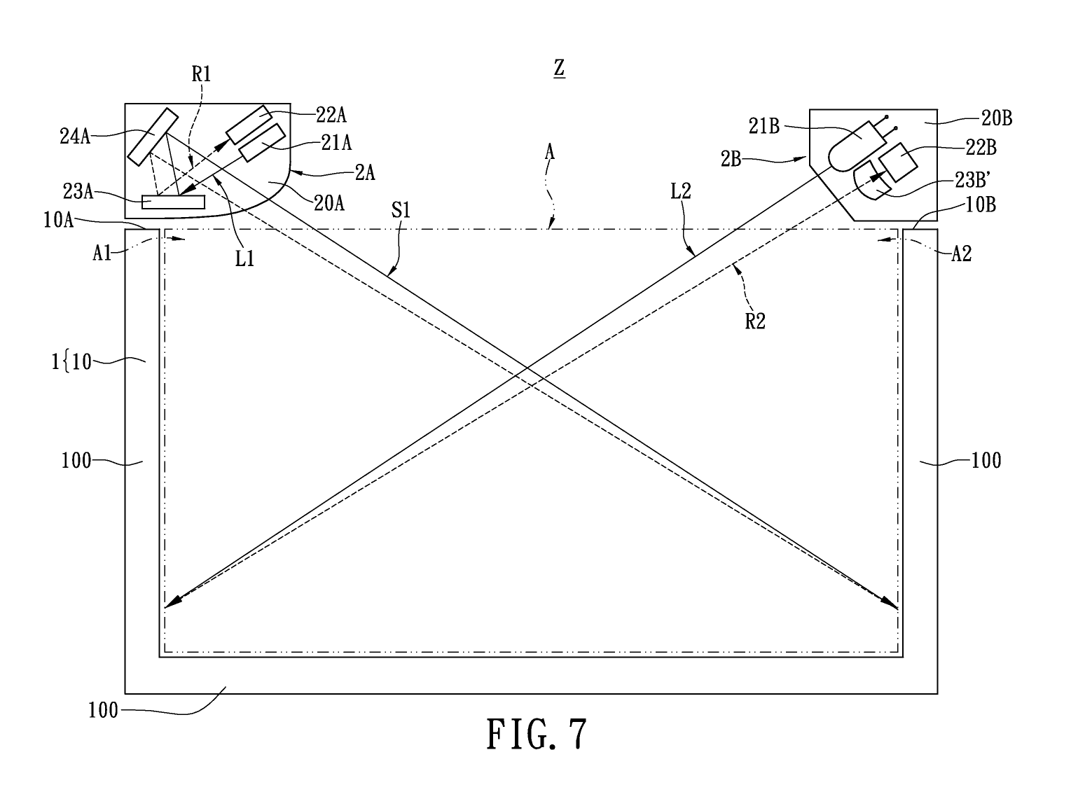

Referring to FIG. 7, where the seventh embodiment of the instant disclosure provides an optical touch control module Z for providing at least one sensing area A, comprising: a light-reflecting unit 1, a first light-sensing unit 2A and a second light-sensing unit 2B. Comparing FIG. 7 with FIG. 6, the difference between the seventh embodiment and the sixth embodiment is as follows: in the seventh embodiment, the first light-sensing unit 2A further includes at least one first fixed reflecting element 24A adjacent to the at least one first oscillating reflecting element 23A. In addition, the at least one first oscillating reflecting element 23A can be disposed transversely along a horizontal direction as shown in FIG. 7, thus the height of the optical touch control module Z can be effectively decreased.

Hence, first projecting light beams L1 generating by the at least one first light-emitting element 21A are sequentially reflected by the at least one first oscillating reflecting element 23A and the at least one first fixed reflecting element 24A to form first scanning light beams S1 that can project onto the light-reflecting element 10 and scan depending on time in the at least one sensing area A, and the first scanning light beams S1 are sequentially reflected by the light-reflecting element 10, the at least one first fixed reflecting element 24A and the at least one first oscillating reflecting element 23A to form first reflecting light beams R1 projecting onto the at least one first light-detecting element 22A. In other words, the first projecting light beams L1 generating by the at least one first light-emitting element 21A are sequentially reflected by the at least one first oscillating reflecting element 23A and the at least one first fixed reflecting element 24A to form the first scanning light beams S1 that can project onto the light-reflecting element 10 and scan depending on time in the at least one sensing area A, and the first scanning light beams S1 are sequentially reflected by the light-reflecting element 10, the at least one first fixed reflecting element 24A and the at least one first oscillating reflecting element 23A to form the first reflecting light beams R1 projecting onto the at least one first light-detecting element 22A.

In conclusion, the optical touch control module of the instant disclosure can provide the scanning light beams that can scan depending on time in at least one sensing area due to the design of the oscillating reflecting element that can oscillate depending on time.

The above-mentioned descriptions merely represent the preferred embodiments of the instant disclosure, without any intention or ability to limit the scope of the instant disclosure which is fully described only within the following claims Various equivalent changes, alterations or modifications based on the claims of instant disclosure are all, consequently, viewed as being embraced by the scope of the instant disclosure.

What is claimed is:

1. An optical touch control module for providing at least one sensing area, comprising:
a light-reflecting unit including a light-reflecting element for partially surrounding the at least one sensing area;
a first light-sensing unit disposed beside one edge of the at least one sensing area and adjacent to one end of the light-reflecting element, wherein the first light-sensing unit includes at least one first light-emitting element, at least one first light-detecting element adjacent to the at least one first light-emitting element, and at least one first oscillating reflecting element oscillating depending on time and adjacent to the at least one first light-emitting element and the at least one first light-detecting element; and
a second light-sensing unit disposed beside another edge of the at least one sensing area and adjacent to another end of the light-reflecting element, wherein the second light-sensing unit includes at least one second light-emitting element, at least one second light-detecting element adjacent to the at least one second light-emitting element, and at least one second oscillating reflecting element oscillating depending on time and adjacent to the at least one second light-emitting element and the at least one second light-detecting element.

2. The optical touch control module of claim 1, wherein first projecting light beams generating by the at least one first light-emitting element are reflected by the at least one first oscillating reflecting element to form first scanning light beams projecting onto the light-reflecting element and scanning depending on time in the at least one sensing area, and the first scanning light beams are sequentially reflected by the light-reflecting element and the at least one first oscillating reflecting element to form first reflecting light beams projecting onto the at least one first light-detecting element, wherein second projecting light beams generating by the at least one second light-emitting element are reflected by the at least one second oscillating reflecting element to form second scanning light beams projecting onto the light-reflecting element and scanning depending on time in the at least one sensing area, and the second scanning light beams are sequentially reflected by the light-reflecting element and the at least one second oscillating reflecting element to form second reflecting light beams projecting onto the at least one second light-detecting element.

3. The optical touch control module of claim 1, wherein the first light-sensing unit includes at least one first fixed reflecting element adjacent to the at least one first oscillating reflecting element, and the second light-sensing unit includes at least one second fixed reflecting element adjacent to the at least one second oscillating reflecting element.

4. The optical touch control module of claim 3, wherein first projecting light beams generating by the at least one first light-emitting element are sequentially reflected by the at least one first oscillating reflecting element and the at least one first fixed reflecting element to form first scanning light beams projecting onto the light-reflecting element and scanning depending on time in the at least one sensing area, and the first scanning light beams are sequentially reflected by the light-reflecting element, the at least one first fixed reflecting element and the at least one first oscillating reflecting element to form first reflecting light beams projecting onto the at least one first light-detecting element, wherein second projecting light beams generating by the at least one second light-emitting element are sequentially reflected by the at least one second oscillating reflecting element and the at least one second fixed reflecting element to form second scanning light beams projecting onto the light-reflecting element and scanning depending on time in the at least one sensing area, and the second scanning light beams are sequentially reflected by the light-reflecting element, the at least one first fixed reflecting element and the at least one second oscillating reflecting element to form second reflecting light beams projecting onto the at least one second light-detecting element.

5. An optical touch control module for providing at least one sensing area, comprising:
a light-reflecting unit including a light-reflecting element for partially surrounding the at least one sensing area; and
a light-sensing unit disposed beside one edge of the at least one sensing area and adjacent to one end of the light-reflecting element, wherein the light-sensing unit includes at least one light-emitting element, at least one light-detecting element adjacent to the at least one light-emitting element, and at least one oscillating reflecting element oscillating depending on time and adjacent to the at least one light-emitting element and the at least one light-detecting element.

6. The optical touch control module of claim 5, wherein projecting light beams generating by the at least one light-emitting element are reflected by the at least one oscillating reflecting element to form scanning light beams projecting onto the light-reflecting element and scanning depending on time in the at least one sensing area, and the scanning light beams are sequentially reflected by the light-reflecting element and the at least one oscillating reflecting element to form reflecting light beams projecting onto the at least one light-detecting element.

7. The optical touch control module of claim 5, wherein the light-sensing unit includes at least one fixed reflecting element adjacent to the at least one oscillating reflecting element, projecting light beams generating by the at least one light-emitting element are sequentially reflected by the at least one oscillating reflecting element and the at least one fixed reflecting element to form scanning light beams projecting onto the light-reflecting element and scanning depending on time in the at least one sensing area, and the scanning light beams are sequentially reflected by the light-reflecting element, the at least one fixed reflecting element and the at least one oscillating reflecting element to form reflecting light beams projecting onto the at least one light-detecting element.

8. An optical touch control module for providing at least one sensing area, comprising:
a light-reflecting unit including a light-reflecting element for partially surrounding the at least one sensing area; and
a light-sensing unit disposed beside one edge of the at least one sensing area and adjacent to one end of the light-reflecting element, wherein the light-sensing unit includes at least one light-emitting element for providing a first phase signal, at least one light-detecting element adjacent to the at least one light-emitting element for receiving a second phase signal in order to obtain the phase difference between the first phase signal and the second phase signal, and at least one oscillating reflecting element oscillating depending on time and adjacent to the at least one light-emitting element and the at least one light-detecting element.

9. The optical touch control module of claim 8, wherein projecting light beams generating by the at least one light-emitting element are reflected by the at least one oscillating reflecting element to form scanning light beams projecting onto the light-reflecting element and scanning depending on time in the at least one sensing area, and the scanning light beams are sequentially reflected by the light-reflecting element and the at least one oscillating reflecting element to form reflecting light beams projecting onto the at least one light-detecting element.

10. The optical touch control module of claim 8, wherein the light-sensing unit includes at least one fixed reflecting element adjacent to the at least one oscillating reflecting element, projecting light beams generating by the at least one light-emitting element are sequentially reflected by the at least one oscillating reflecting element and the at least one fixed reflecting element to form scanning light beams projecting onto the light-reflecting element and scanning depending on time in the at least one sensing area, and the scanning light beams are sequentially reflected by the light-reflecting element, the at least one fixed reflecting element and the at least one oscillating reflecting element to form reflecting light beams projecting onto the at least one light-detecting element.
